(19) United States
(12) Patent Application Publication
(10) Pub. No.: US 2004/0151360 A1
(43) Pub. Date: Aug. 5, 2004

(54) Method and apparatus for measuring particles by image analysis

(76) Inventors: Eric Pirard, Esneux (BE); Christian Godino, Liege (BE)

Correspondence Address: JACOBSON HOLMAN PLLC, 400 SEVENTH STREET N.W., SUITE 600, WASHINGTON, DC, 20004, US

(21) Appl. No.: 10/482,221

(22) PCT Filed: Jun. 27, 2002
(86) PCT No.: PCT/EP02/07209

(30) Foreign Application Priority Data
Jul. 2, 2001 (EP) 01202539.1

(51) Int. Cl. G06K 9/00

(52) U.S. Cl. 382/141; 382/110

(57) ABSTRACT

Apparatus for measuring by image analysis the granulometry, the morphometry and the optical surface properties of particles, comprising a device for dispersing particles in a monolayer connected to another device for transporting the particles in a movement which is horizontal, level and perpendicular to the optical axis into the focal field of an optical system which in turn is connected to a device for taking images of said particles and analysing same with regard to granulometry, morphometry and texture.

The present invention relates to a method and apparatus for measuring particles by image analysis, more particularly for automatically measuring the size, shape and optical properties of particles.

The size, shape and optical properties of particles are essential for understanding and analysing their mechanical behaviour (apparent density with and without settling, flow mobility, shear resistance, angle of repose, etc.) their tribological and their chemical behaviour (dissolution kinetics, electrical capacity, etc.).

The size grading of particles, or granulometry, must conform to standards. The majority of current granulometric standards are defined with reference to the use of sieves for fractions of particles larger than 40 μm, and to laser beam diffraction for finer granulometries.

According to the state of the art imaging techniques are often used for individual analysis of particles. Imaging techniques are not appropriate to the concept of a mechanical and optoelectronic system designed to automate measurement and obtain an unbiased estimation of the granulometric and morphometric properties of a sample comprising a plurality of thousands of particles. These techniques are difficult to render compatible with the standards established on the basis of measurements derived from sifting.

The existing apparatuses which utilise a principle of image analysis (also referred to as video-granulometry in this case) are based essentially on imaging of particles when in free fall at the exit of a vibrating trough. This technical approach does not allow the fall velocity and still less the position of particles opposite a camera to be monitored. The imprecision regarding velocity impairs image quality, while the imprecision regarding position does not allow the dimension of the particle critical for its passage through a sieve to be displayed. In addition, overlapping of particles, which also leads to incorrect evaluation of granulometry, is always possible. Moreover, two particles clearly separated in space may produce overlapping shadows by projection, likewise leading to incorrect evaluation of granulometry.

More particularly, patent application WO 94/06092 describes a system for the automatic granulometric measurement of particles by image analysis. The system includes a conveyor belt driven in horizontal translation. This conveyor belt is provided with transverse grooves designed to orient the particles in a preferential direction. In addition, the grooves are separated by a spacing chosen as a function of the size of the particles to be analysed. Images are produced by episcopy using a camera placed above the conveyor belt. The system is equipped with annular lighting means placed concentrically around the camera lens. This system is designed to classify the grains of a batch of seeds on the basis of measurements of crossing lengths and of colours in the image. The feed rate of the belt, which is interrupted each time an image is produced, is designed to analyse approximately 300 particles per minute. A weight proportion is estimated empirically on the basis of a projected surface of each particle.

The apparatus described in WO 94/06092 does not permit information on a critical sifting diameter to be acquired since the particles are not in a level position at rest because of the use of grooves in the conveyor belt.

Furthermore, episcopy does not allow geometrically correct information to be acquired for precise measurement of the size and shape of a particle. Finally, the apparatus is not adapted to the dispersion and imaging of excessively fine particles (e.g. 100 μm), and impairs the properties of friable particles (e.g. soluble coffee) through contact with moving mechanical elements.

We have now found that as a result of a combination of a certain number of devices the apparatus described in the present invention permits a sifting curve for a material of homogenous density to be estimated optimally, while presenting significant advantages in terms of accuracy, representativity, speed, automation and digital information processing. As a result of this combination of devices it is now possible to measure geometric characteristics not accessible by other methods, such as the morphology (concavity, roughness, bluntness, angularity, reactivity, presence of holes, etc.) of particles. According to the same principle, it is possible to measure optical surface properties (colour, brightness, texture, transparency, etc.) conjointly. It is also possible to develop rigorous three-dimensional mensuration.

Image analysis, in particular analysis of digital images, is a technique which allows the individual geometric properties of each particle to be investigated. Its correct implementation requires the proper execution of the following stages:

taking of a representative sample

optimum dispersion of the particles

monitoring of the spatial position and feed velocity of each particle

illumination of the profile or the surface of the particle

production of a digital image

analysis of relevant geometric parameters

estimation of the properties of a distribution by number or by measurement.

The present invention relates to an apparatus for measuring particles by image analysis, comprising:

a device for dispersing particles in such a manner as to prevent overlapping, connected to

a device for transporting the particles into the focal field of an optical system connected to

a device for producing digital images of said particles and analysing same,

characterised in that the particles are dispersed in a monolayer on one or more transparent, flat, rigid plates, said plates being transported with a level horizontal motion and positioned perpendicularly to the axis of the optical system for analysis of each digital image.

This apparatus is suitable for a range of particles of between 5 μm and 5 mm, whether said particles are mineral powders (sands, coals, abrasives, etc.), metallic polymeric or ceramic powders, pharmaceutical granules and pellets, fertilisers, seeds or agri-food products.

This apparatus may be used, for example, as a laboratory instrument for inspecting the quality of products, or it may equally be fitted to a production line, for example, in the mineral, metallurgical, chemical, pharmaceutical, agricultural, agri-food and plant protection industries.

The device for dispersing particles in such a way as to prevent overlapping may also be supplemented by a rotary sampler. This sampler is designed to reduce in an unbiased manner the quantity of material required, given that very high measuring accuracy can be obtained with only a few grams of material, or a few thousands of particles.

The sampler may be removable and may be bypassed if it is desired to analyse the material in its totality or if its friability/ductility necessitate the limitation of mechanical shocks. In that case the material may be fed directly into a vibrating trough the purpose of which is to draw out a flow of particles and to supply a regular delivery to the system. Adjustable vibration of the trough allows a frequency to be adapted to the response properties of the granular material used.

On exiting the trough the particles are fed via a height-adjustable chute to a horizontal, transparent, flat, rigid plate or series of such plates on which they are immobilised before entering the focal field of the optical system, more particularly the image-taking field of a camera. As they adopt a stable position the particles will naturally orientate their smallest diameter according to the optical axis of the imaging system (perpendicular to the plates). Their intermediate diameter (D_{IN}) which conditions the passage of a particle through a sieve is therefore parallel to the plate and visible in an image plane. The plates form part of the device for transporting the particles from the chute of the vibrating trough to the discharge point and the plate-cleaning point.

The dispersion of the particles on the plate or plates is regulated by the vertical distance between the vibrating trough and the transporting device, and by the feed velocity of the transporting device.

Under operating conditions according to the invention, the particle dispersing device enables any overlapping of particles on the plates to be avoided and very low rates of coherence of particles to be achieved. These are, for example, of the order of 1/400 for a sand and 1/200 for a soluble coffee, which rates are statistically negligible and may be subject to filtering during computer analysis of the data.

By combining mechanically independent vibration and acceleration systems the particle dispersing device is able to disperse materials having very variable intrinsic characteristics (glass balls, polyethylene granules, silica sands, metal powders, freeze-dried particles, etc.).

For materials which are more adherent, slightly moist or loaded with fine particles it may be desirable to adopt a dispersion method using compressed air at the exit of the vibrating trough, for example, for powdered milk.

The device for transporting the particles into the focal field of a lens system includes one or more horizontal plates on which the particles are dispersed. These plates must have a light transmitting capacity of more than 90%, must avoid any diffusion of the light and must be free of any mass or surface defect which might be perceptible to the optical system. The plates must be flat and must have sufficient hardness to resist abrasion and scratching by particles of silica. More precisely, the rigidity and flatness of the plates must be such that the difference in distance in the image plane between the highest and lowest points of the plate does not exceed the depth of focus of the system.

The plates are preferably made of optical quality glass.

The plates are transported in a horizontal movement and are positioned perpendicularly to the axis of the optical system for the analysis of each digital image. The plates move preferably at constant velocity. The perpendicularity of the plates to the optical axis as they pass into the visual field of the system is ensured by the supplementary use of a guidance system including, for example, Teflon slides. The displacement of the particles during the imaging process takes place, from that time, in a perfectly horizontal plane.

Furthermore, because of the mechanical independence of the guidance system, the vibrations of the trough do not affect the particles during imaging.

The particles are therefore subjected to a horizontal, level movement at constant velocity, while being perpendicular to the optical axis.

According to a particular embodiment of the invention the plates are attached to a conveyor belt. The conveyor belt preferably comprises two parallel belts guided by two toothed wheels.

Each particle dispersed on a horizontal plate then adopts its position of equilibrium, which is such that its centre of gravity is as low as possible. The particle is simultaneously moved into the focal field of an optical system.

According to another embodiment of the invention, the plates are attached to a circular platform made up, for example, of a steel disc welded to a motor-driven axle. A speed of rotation may be regulated in combination with an intensity of vibration of the trough to optimise the dispersion of the particles on the plate or plates.

The optical system according to the invention makes use of conventional episcopic (illumination from above) or diascopic (illumination from below) lighting systems or a combination of both, but preference is given to diascopic illumination and to its combination with episcopic illumination.

For granulometric and morphometric analysis collimated back-lighting and a telecentric lens system are preferably chosen. It is then possible to produce a precise image of the projected shadow of each particle along an axis perpendicular to the transparent plate. It can be demonstrated that the critical diameter of the particle for its passage through a sieve corresponds to the diameter of the largest inscribed circle (D_{IN}) in the projected surface of the particle.

It is also possible to take images of particles on the plate using diffuse episcopic or specular or coaxial light in such a manner as to obtain information on a colour, a reflectance and a surface state of each particle. It is also possible to utilise this controlled position of the particle to measure the thickness of the particle (height relative to the plane of the glass plate) by using a principle of laser triangulation or confocal laser imaging.

In particular, collimated illumination by LED and a telecentric lens system enable the depth of focus to be optimally increased and optimum imaging conditions for each particle to be ensured.

As a result of uniformity of illumination and optimum optical conditions, the shadow of each particle stands out very sharply against the background. This contrast remains applicable for transparent particles such as diamonds or glass balls. Imaging in the collimated mode provides a high-contrast contour which will be sufficient to eliminate the transparent regions within the grains by software means. The use of a uniform, adjustable threshold in an interactive manner is sufficient to acquire the projected shadow of each particle.

Imaging may be carried out, for example, using a linear or matrix CCD camera. These cameras have image-taking frequencies which may be adjusted as a function of the feed velocity of the transporting device, in particular the conveyor belt.

Thus, the following may be defined: Vmax for the maximum feed velocity of each plate, in particular on the conveyor belt; Ts for a determinate exposure time of the particle in the focal field of the optical system, and PMP for loss of precision during the taking of an image. Loss of precision is understood to mean displacement of the particle during image taking. If a calibration G allows determination of how many pixels are contained in a reference interval of known dimension, the equation

Vmax=(PMP*G)/(Ts)

may be used to calculate the feed velocity up to a precision of PMP. For example, for a PMP of less than 3 pixels, a G of 24 μm per pixel and a Ts of 50 microseconds, a feed velocity Vmax of 1440 mm/s is obtained.

The illumination brightness may be increased if required to compensate for the loss of intensity of contrast resulting from greater acquisition speeds. As an indication, analysis of 5000 particles per minute in the range of 200 μm can be achieved in granulometry and morphometry with an entirely conventional CCD matrix camera.

It should be noted that the extent of the granulometric distribution which can be analysed in a single pass depends on the optical system used and on the resolution of the imaging device. Use of linear CCD cameras makes it possible to envisage a resolution sufficient for treating dimensional ranges from 5 μm to 5 mm. A current CCD camera (e.g. 1300×1024) enables granulometric dynamics of 1:1000 to be treated. A dynamic analysis of at least 1:200 will preferably be chosen, while taking account of a probability of particle inclusion in the image and while eliminating noise.

A greyscale or colour image can therefore be obtained. It will be thresholded to obtain a binary image on the basis of which it is possible to analyse by software means information relating to the surface and the perimeter of the object projected, to the surface and perimeter of the convex envelope, to Feret diameters, to elongation, to the diameter of the inscribed circle, to numerous other morphometric concepts derived from original work in mathematical morphology, to reflectance, to light transmitting capacity, to colour, to texture and to numerous other measurements of size, shape and optical surface properties.

As a result of the precision in measuring the diameter of the inscribed circle (D_{IN}) and the adoption of precise estimation of the relative weight of each particle, it is possible to evaluate a granulometric curve in terms of volume for a batch of particles. By hypothesising the relative density of the granulometric fractions it is possible to estimate the granulometric curve in terms of weight.

It is important to emphasise that no special parametrics are necessary to carry out measurement using the apparatus according to the invention, but that measuring accuracy depends on the quality of the dispersion and on the control of the positioning of each particle, and on the precision of the imaging.

As a result of complete automation of the process, statistics on the particles (count, mean value, variance, correlations, histograms, etc.) can be delivered in real time as the particles are being fed. The individual contours of each particle (Freeman chain) are associated in the database with their geometric measurements, allowing the results obtained to be interrogated at all times. When the particles leave the focal field of the lighting system they are recovered.

The apparatus according to the invention preferably includes a plate-cleaning system. After passing into the focal field of the optical system, the particles are removed from the plates, in particular in the lower portion of the conveyor belt or in the portion of the circular platform opposite the camera. Most of the particles fall by gravity and are recovered in a collector. The smallest particles may be detached by means of one or more brushes.

The invention will now be described with reference to the following drawings and examples:

### BRIEF DESCRIPTION OF THE DRAWINGS:

FIG. 1a Diagram of imaging by back-lighting and telecentric lens system;

FIG. 1b Enlargement of a part of FIG. 1a concerning the projection of the image of the particle on to an imaging device, showing a critical diameter of the inscribed circle;

FIG. 2 Diagram of the model of the embodiment of the apparatus according to the invention;

FIG. 3 Diagram of the system for controlling the delivery between the outlet of the sampler and the conveyor belt;

FIG. 4 Parallelism and synchronisation of the two toothed belts and fixing for a glass plate;

FIG. 5 Diagram of the guidance system of the conveyor belt to ensure horizontality of the plates;

FIG. 6 Diagram of the alternative device for guiding the particles by means of a rotating platform;

FIG. 7 Diagram of imaging by means of the camera.

In FIG. 1a the particle Q is disposed on a transparent, flat, rigid plate P.

A light source S emits a light beam on to the particle Q by means of a lens L, generating an image I of the shadow of the particle which is projected along an axis perpendicular to the transparent plate P on to an imaging device such as a CCD camera. The critical diameter for passing through a sieve corresponds to the diameter D_{IN} of the largest circle inscribed in the projected surface i (FIG. 1b).

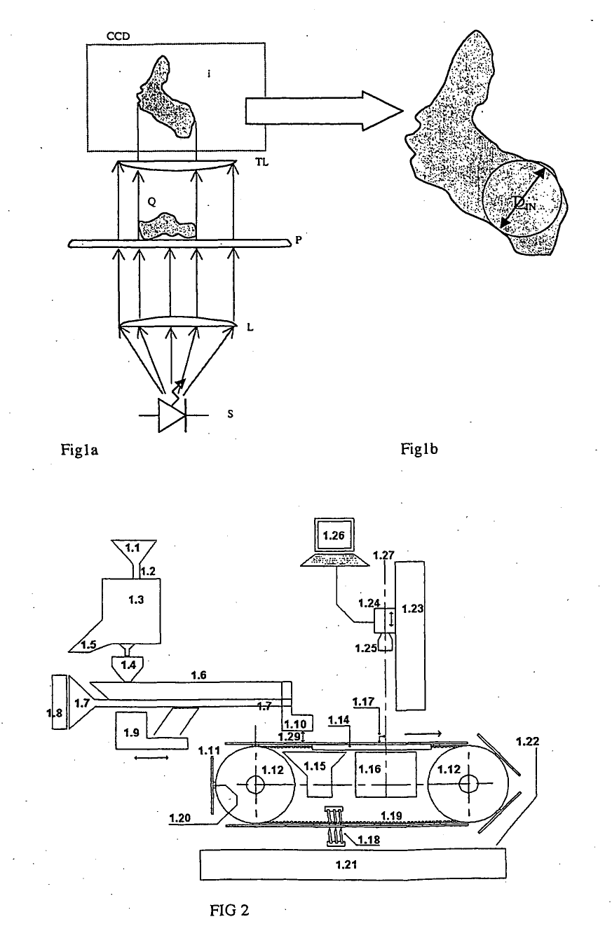

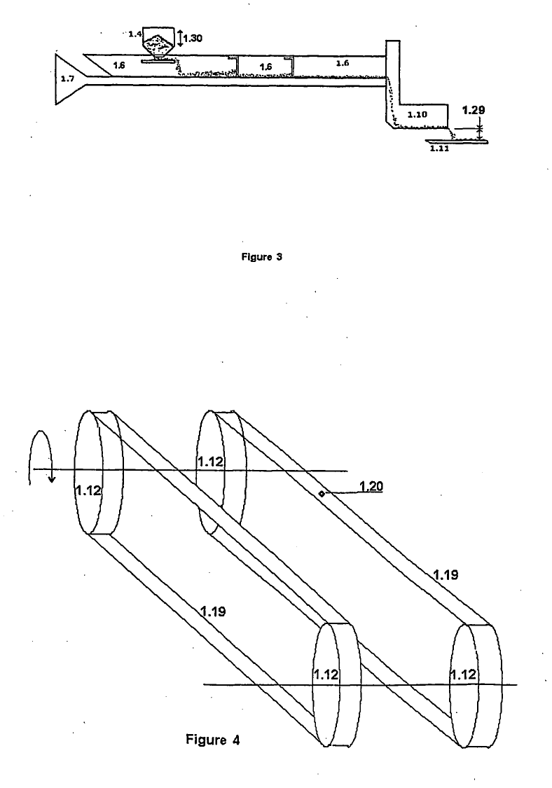

FIG. 2 illustrates an embodiment of the apparatus according to the invention.

The particles are fed through a funnel (1.1) and pass through a control valve (1.2) before falling into a rotary sampler (1.3). The sampler is formed by a cone having a rectangular opening, the speed of which cone can be continually adjusted so as to produce a regular delivery of material. On leaving the sampler a flow of particles falls on to a vibration generator (1.9), the trough of which is formed by three parts 1.4, 1.6 and 1.10, then on to the glass plates fixed to two toothed belts 1.19 which move the particles into the focal field of a lens system 1.16. The end part 1.10 is used to allow the particles to be brought as close as possible to the glass plates 1.11 and to avoid excessive dispersion of the particles. Its height (1.29) is therefore adjustable.

Small quantities of particles may fall into the gap between two adjacent plates; they are then recovered in a collector (1.15).

After passing under the optical axis (1.27) the particles are deposited by gravity on to a chute (1.22). A system of multiple movable brushes (1.18) ensures permanent cleaning of the plates before they move back under the pouring point of the trough.

The totality of powders collected by the systems 1.15, 1.18 and 1.22 falls by gravity into a recovery container (1.21).

Regulation of the delivery of material between the outlet of the sampler and the part 1.6 is effected by means of a conical funnel (1.4) of adjustable height (1.30) (FIG. 3). As shown in FIG. 3, the delivery may also be controlled by the addition of partitions of variable profile in the conduit of part 1.6. For materials which are more adherent, slightly moist or loaded with fine particles it may be desirable to adopt a dispersion method using compressed air at the exit of the vibrating trough. A compressor (1.8) provides a regular flow of air which is guided, by means of a duct arranged below the vibration generator (1.7), up to the point where the powders are poured on to the plates. FIG. 4 shows the conveyor belt formed by two parallel belts guided by two toothed wheels 1.12. A series of threaded brass elements 1.20 is fixed to the lower portions of the two belts of the device which transports the particles into the focal field of the lens system. The two belts of the conveyor belt are motor-driven and synchronised. Each transparent plate is fixed to the belts of the conveyor belt by screws preferably made of nylon.

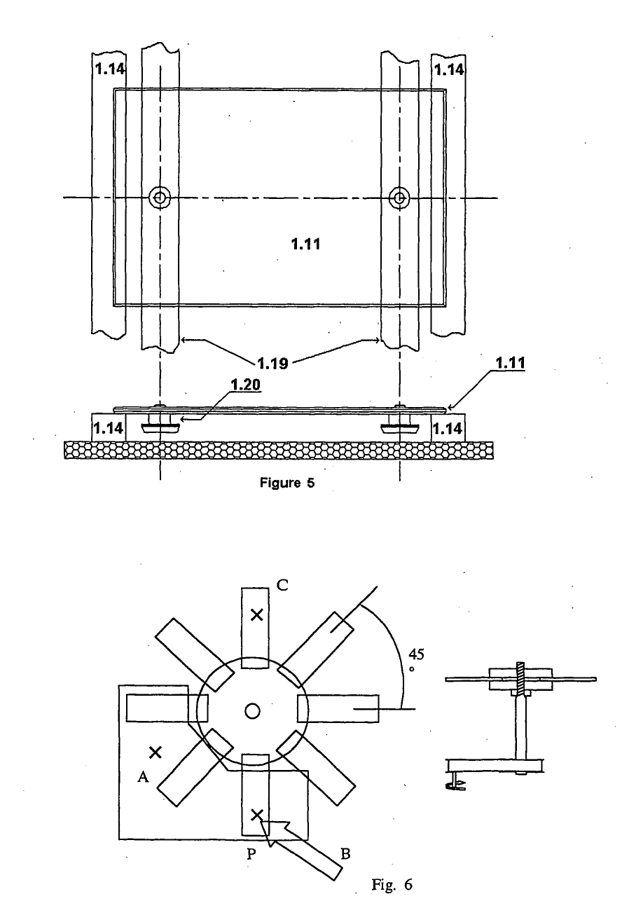

FIG. 5 shows the guidance system 1.14 which is fixed to the frame (not shown) perpendicularly (1.17) to the optical axis (1.27). This enables positioning in the focal plane and ensures the horizontality of the plates 1.11 as they pass into the imaging field of the camera.

The plates 1.11 are moved by the belts 1.19 on slides (1.14). The distance 1.28 between the lens of the camera 1.25 and the surface of the plates is adjustable and is strictly monitored so that focusing is ensured.

Calibration of the optical system may be effected by means of a glass plate having a reticle. The image of the reticle is focused by adjusting the level (1.23) of the CCD camera 1.24.

A second embodiment according to the invention is illustrated in FIG. 6. In this embodiment the device which moves the particles into the imaging field is formed by a circular platform such as a steel disc on which the preferably glass plates are fixed. The steel disc is welded to a motor-driven axle. The rotational speed is adjustable, and the combination between this speed and the intensity of vibration of the vibrating trough allows the dispersion of the particles on the plate to be optimised.

The image-taking device, for example a CCD camera, is synchronised with the position of the plates. An external synchronisation signal is generated by a photodiode. Each time a plate passes, a detection system sends a pulse to the camera. The image is therefore stored in the camera and analysed in real time by software. Using a simple thresholding procedure, the software enables the contour of the shadow of the particle to be extracted for analysis of its size and shape. The number of images taken depends on the speed of rotation and on the number of plates fixed to the disc (for example, 8 plates), but an upper limit is also imposed by the calculating speed of the computer.

A recovery or collection container may also be fixed in the lower portion of the disc, the particles which fall between the plates being collected in this container.

The particles which are analysed are loaded on to the plates at the outlet A of a vibrating trough as in the first embodiment of the invention. The image is taken at C in correspondence with the axis of the camera, and to complete the process a very supple brush B cleans the surfaces of the plates P. These last particles are also collected in the same container R.

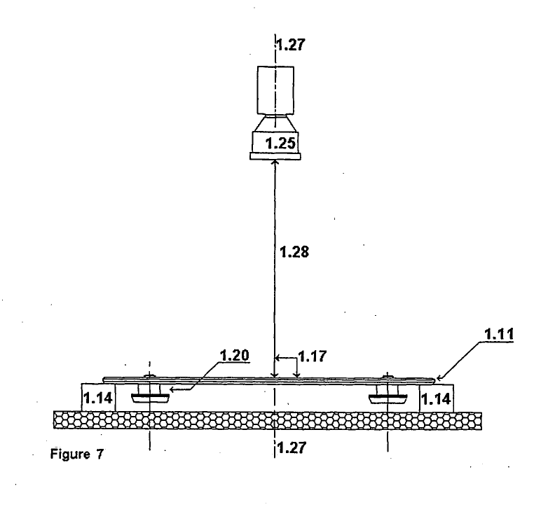

FIG. 7 shows the image-taking process by means of the assembly comprising the camera 1.24 and the lens 1.25. The plate 1.11 is fixed to the transmission belt (not shown) by means of collars 1.20. The axis 1.27 of the lens system forms an angle 1.17 strictly perpendicular to the plate 1.11 as a result of the guidance system 1.14.

### EXAMPLE 1

### Comparison of the Method According to the Invention with the Sifting Method

The method according to the invention is referred to below. as ALPAGA and has been compared with the results of sifting obtained with 100 g of BCR-68 sand used by five different laboratories and recognised by the European body BCR (Community Bureau of Reference). Table 2 shows the good agreement between the measurements.

Table 2

Comparison of the Method According to the Invention with Sifting Methods.

The sifting values express the weight fraction of the particles smaller than the dimension indicated in micrometres. For each fraction the table provides an average Q₃ and an uncertainty S_{R}(Q₃) regarding the values obtained by the five laboratories of BCR. It should be stressed that the analysis carried out with ALPAGA relates to the equivalent of 6 g of sand, as compared to the hundred grams used by the BCR laboratories.

Sifting

| μm | Q₃ | Sᵣ (Q₃) | ALPAGA |
|---|---|---|---|
| 160 | 4.2 | 0.9 | 3.89 |
| 250 | 22.9 | 3.2 | 20.68 |
| 320 | 44.9 | 2.4 | 39.80 |
| 400 | 68.9 | 2.7 | 67.95 |
| 500 | 88.8 | 1.2 | 88.87 |
| 630 | 97.4 | 0.9 | 98.24 |

1. Apparatus for measuring particles by image analysis, comprising:
a device for dispersing particles in such a way as to prevent their overlapping, connected to
a device for transporting the particles into a focal field of an optical system connected to
a device for producing digital images of said particles and analysing same,
characterised in that the particles are dispersed in a monolayer on one or more transparent, flat, rigid plates, said plates being transported in a level horizontal motion and positioned perpendicularly to the axis of the optical system for analysis of each digital image.

2. Apparatus according to claim 1, for granulometric and morphometric analysis and for analysis of optical surface properties of particles.

3. Apparatus according to either of claims 1 and 2, wherein each plate on which the particles are dispersed is attached to a conveyor belt.

4. Apparatus according to claim 3, wherein the conveyor belt comprises two parallel belts guided by two toothed wheels.

5. Apparatus according to either of claims 1 and 2, wherein the plate on which the particles are dispersed is attached to a circular platform.

6. Apparatus according to any one of the preceding claims, characterised in that each plate has a light transmitting capacity of more than 90% and is free of any mass or surface defect which might be perceptible by the optical system.

7. Apparatus according to any one of the preceding claims, also comprising a plate-cleaning system.

8. Apparatus according to any one of the preceding claims, wherein the optical system includes diascopic illumination means.

9. Apparatus according to claim 8, wherein the optical system includes collimated illumination means and a telecentric lens system.

10. Apparatus according to either of claims 8 and 9, also including episcopic illumination means.

11. Method for particle measurement by image analysis, comprising the stages of:
dispersion of the particles in such a way as to prevent their overlapping, followed by
transporting of the particles into a focal field of an optical system and production of digital images of the particles followed by analysis of same,
characterised in that the particles are dispersed in a monolayer on one or more transparent, flat, rigid plates, said plates being transported in a level horizontal motion and positioned perpendicularly to the axis of the optical system for analysis of each digital image.

12. Method according to claim 11 for granulometric and morphometric analysis and analysis of optical surface properties of particles.

13. Method according to either of claims 11 and 12, characterised in that each plate has a light transmitting capacity of more than 90% and is free of any mass or surface defect which might be perceptible by the optical system.

14. Method according to any one of claims 11 to 13, also comprising a stage for cleaning the plates after they have passed into the focal field of the optical system.

15. Use of the apparatus according to any one of claims 1 to 10 to carry out quality inspection of product.

16. Use of the apparatus according to any one of claims 1 to 10 in a production line.
